(19) United States
(12) Patent Application Publication
(10) Pub. No.: US 2026/0034774 A1
(43) Pub. Date: Feb. 5, 2026

(54) TEXTILE FABRIC

(71) Applicant: JHIH HUEI TRADING CO., LTD., CHANGHUA COUNTY (TW)

(72) Inventor: YUNG-YU WU, Changhua County (TW)

(21) Appl. No.: 18/794,337

(22) Filed: Aug. 5, 2024

(51) Int. Cl. B32B 27/12; B32B 3/26; B32B 3/28; B32B 3/30; B32B 5/02; B32B 27/30; B32B 27/40; D04B 1/18; D04B 21/18

(52) U.S. Cl. CPC B32B 27/12; B32B 3/266; B32B 3/28; B32B 3/30; B32B 5/026; B32B 27/304; B32B 27/40; D04B 1/18; D04B 21/18; B32B 2307/51; B32B 2307/724; B32B 2307/7265; B32B 2307/7376

(57) ABSTRACT

A textile fabric is provided, including: a main body, a film layer and a covering layer. The main body includes two surfaces opposite to each other, and each of the two surfaces has a surface texture being concave and convex. The film layer is coveringly disposed on one of the two surfaces and is concave and convex corresponding to the surface texture, and the covering layer is coveringly disposed on the other of the two surfaces. Therefore, the film layer has an appearance corresponding to the surface texture, and the textile fabric has good toughness, is waterproof and is not easily damaged, and the covering layer provides comfortable feeling of touching.

### BACKGROUND OF THE INVENTION

### Field of the Invention

The present invention relates to a textile fabric.

### Description of the Prior Art

Textile fabrics are made by a plurality of yarns through different techniques such as knitting and weaving, and they are widely used in daily life including clothing, shoe uppers, bags, etc. To achieve waterproof and toughening effects, surfaces of the textile fabrics may be coated with a waterproof coating, or the plurality of yarns may be covered with a waterproof coating before weaving or knitting.

However, the meshes of the textile fabric may be covered and filled up by the waterproof coating on the surfaces, which results in poor softness and poor appearance of the textile fabric, and easy peeling of the waterproof coating. The plurality of yarns with the waterproof coating may have poor flexibility and high frictional resistance, which is inconvenient to processing and provides poor tactile feel of the textile fabric. In addition, when the meshes of the textile fabrics are large, the textile fabric made by the plurality of yarns with the waterproof coating still cannot achieve waterproof effect.

The present invention is, therefore, arisen to obviate or at least mitigate the above-mentioned disadvantages.

### SUMMARY OF THE INVENTION

The main object of the present invention is to provide a textile fabric, which is waterproof, has good appearance and is comfortable to use.

To achieve the above and other objects, the present invention provides a textile fabric, including: a main body, a film layer and a covering layer. The main body includes two surfaces opposite to each other, and each of the two surfaces has a surface texture being concave and convex. The film layer is coveringly disposed on at least one of the two surfaces and is concave and convex corresponding to the surface texture. The covering layer is coveringly disposed on the other of the two surfaces.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a side view of a preferable embodiment of the present invention; and

FIG. 3 is a partial cross-sectional view of a preferable embodiment of the present invention.

### DETAILED DESCRIPTION OF THE PREFERRED EMBODIMENTS

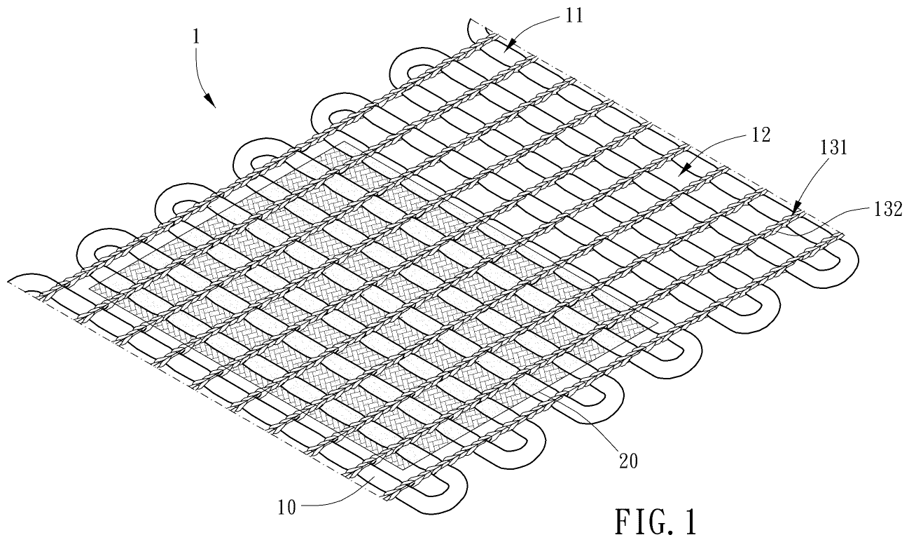

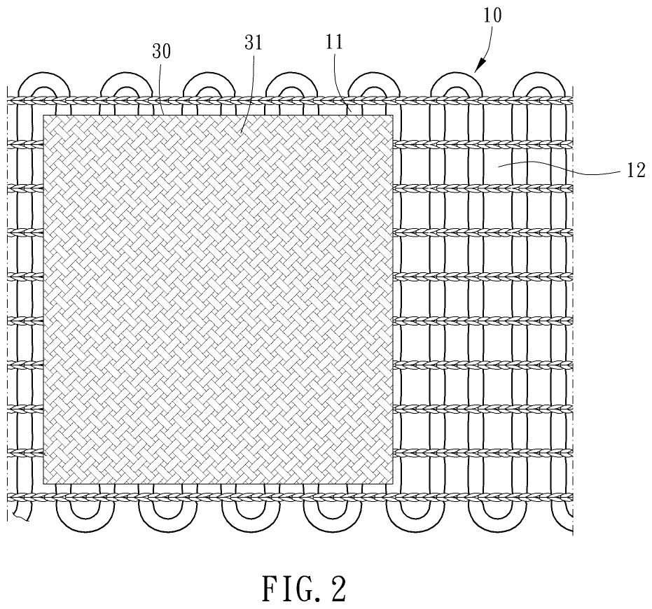

Please refer to FIGS. 1 to 3 for a preferable embodiment of the present invention. A textile fabric 1 of the present invention includes a main body 10, a film layer 20 and a covering layer 30.

The main body 10 includes two surfaces 11 opposite to each other, and each of the two surfaces 11 has a surface texture being concave and convex. The film layer 20 is coveringly disposed on one of the two surfaces 11 and is concave and convex corresponding to the surface texture of one of the two surfaces 11, and the covering layer 30 is coveringly disposed on the other of the two surfaces 11. Therefore, the film layer 20 have an appearance corresponding to the surface texture of the main body 10, and the textile fabric 1 has good toughness and is waterproof and not easy to be damaged.

The film layer 20 is made of a material including at least one of polyurethane and polyvinyl chloride, and a thickness of the film layer 20 is between 20 μm and 450 μm. Therefore, the film layer 20 can increase the structural strength of the textile fabric 1, and the appropriate thickness of the film layer 20 avoids reducing the flexibility of the textile fabric 1 so as to provide good adhesion and be not easy to peel off. In this embodiment, the film layer 20 is made of a material including polyurethane and is a waterproof breathable film layer so as to have advantages of wear-resistant, good toughness, environmentally friendly and decomposable. The thickness of the film layer 20 is preferably between 50 μm and 400 μm so as to provide sufficient wear-resistant effect.

Specifically, the film layer 20 includes a film material layer 21 and a connecting layer 22, and the connecting layer 22 is disposed on a side of the film material layer 21 and connected with one of the two surfaces 11. A thickness of the connecting layer 22 is smaller than or equal to a thickness of the film material layer 21, which facilitates connection between the film layer and the main body 10. A material of the connecting layer 22 is preferably different from a material of the film material layer 21, for example, the film material layer 21 may be made of thermoplastic polyurethane, and the connecting layer 22 may be made of a material that has preferable bonding strength with the main body 10 for stable connection. The film material layer 21 is preferably integrated with the connecting layer 22 in advance. For example, the connecting layer 22 may be partially or completely pre-coated, spayed or filmed on a side of the film material layer 21 so that the film layer 20 is convenient to be used during processing. A color and a transmittance of the film layer 20 may be changed according to design requirements. For example, the film layer 20 may be colorless and light permeable so that a color and a pattern of the main body 10 can be shown; the film layer 20 may be colored so as to be matched with a portion of the main body 10 without the film layer 20 to generate various visual effects.

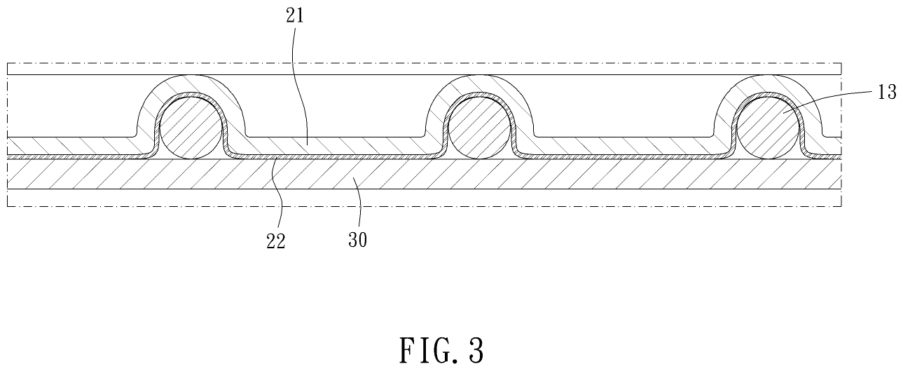

Preferably, the main body 10 includes a plurality of first holes 12, and the film layer 20 is recessed within the plurality of first holes 12 and connected with the covering layer 30, as shown in FIG. 3, so that the covering layer 30 is attached to one of the two surfaces 11 by the connecting layer 22. Therefore, the covering layer 30 and the main body 10 are connected with each other without additional adhesive, which increases processing efficiency and reduces manufacturing cost. In this embodiment, a diametrical dimension of each of the plurality of first holes 12 is larger than or equal to 2 mm, and a depth of the film layer 20 recessed within one of the plurality of first holes 12 is larger than a depth of the covering layer 30 recessed within one of the plurality of the first holes 12 so that the film layer 20 is greatly recessed into the plurality of first holes 12, which provides an obvious concave-convex visual effect. A material of the film layer 20 is different from a material of the covering layer 30, and the covering layer 30 is a fabric, such as cotton, linen, canvas, wool, etc., and includes a plurality of second holes 31. The material of the covering layer 30 is selectable to meet different requirements. A diametrical dimension of one of the plurality of second holes 31 is smaller than the diametrical dimension of one of the plurality of first holes 12; and a fabric density of the covering layer 30 is larger than a fabric density of the main body 10. Therefore, the covering layer is configured to provide comfortable feeling of touching. During manufacturing, the covering layer 30, the main body 10 and the film layer 20 are stacked on a platform with a plurality of suction holes in sequence, and then air is extracted through the plurality of suction holes and a hot plate is pressed on a side of the film layer 20 opposite to the main body 10. As a result, the covering layer 30, the main body 10 and the film layer 20 are integrally connected with one another, which is easy to operate. In other embodiments, the material of the covering layer may be the same with the material of the film layer so as to make two sides of the textile fabric waterproof and enhance a structure of the main body.

The main body 10 further includes a plurality of yarns 13, and the plurality of yarns 13 are interlaced with one another to form at least one knitted structure 131 and the plurality of first holes 12. In this embodiment, the plurality of yarns 13 have two different diametrical dimensions. The at least one knitted structure 131 includes a plurality of loops 132 sleeved to one another. As viewed in an axial direction of one of the plurality of yarns 13, the film layer 20 covers at least ⅓ of an outer circumferential surface of said yarn 13, as shown in FIG. 3. With the film layer 20, the problem that existing knitted fabrics are easily decomposed when cut can be solved, and the textile fabric 1 of the present invention has a stable structure and is convenient to use. Moreover, the sleeving structures of the plurality of loops 132 also provide obvious concave and convex three-dimensional structures, and the film layer 20 disposed thereon has obvious concave and convex appearance. The plurality of yarns 13 are at least partially elastic yarns so that a portion of the main body 10 without the film layer 20 can maintain its original stretch elasticity to meet different requirements. An area of the covering layer 30 covering the main body 10 is smaller than or equal to an area of the film layer 20 covering the main body 10 so as to provide waterproof effect.

In summary, the film layer 20 of the present invention covers the plurality of first holes 12 to achieve waterproof, breathable and anti-slip effects, and the plurality of yarns 13 are held in place by the film layer 20 so that the textile fabric 1 has excellent tensile strength and maintains good flexibility. In addition, the covering layer 30 provides comfortable feeling of touching; the color of the film layer 20 is changeable to provide various appearances, and the film layer is concave and convex corresponding to the surface texture of one of the two surfaces of the main body 10, providing special visual effect.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A textile fabric, including:
a main body, including two surfaces opposite to each other, each of the two surfaces having a surface texture being concave and convex;
a film layer, coveringly disposed on one of the two surfaces and being concave and convex corresponding to the surface texture of one of the two surfaces; and
a covering layer, coveringly disposed on the other of the two surfaces.

2. The textile fabric of claim 1, wherein the film layer is made of a material including at least one of polyurethane and polyvinyl chloride.

3. The textile fabric of claim 1, wherein the film layer includes a film material layer and a connecting layer, and the connecting layer is disposed on a side of the film material layer and connected with one of the two surfaces.

4. The textile fabric of claim 1, wherein a material of the film layer is different from a material of the covering layer.

5. The textile fabric of claim 1, wherein the main body includes a plurality of first holes, and the film layer is recessed within the plurality of first holes and connected with the covering layer.

6. The textile fabric of claim 5, wherein a depth of the film layer recessed within one of the plurality of first holes is larger than a depth of the covering layer recessed within one of the plurality of first holes.

7. The textile fabric of claim 5, wherein the covering layer is a fabric and includes a plurality of second holes, and a diametrical dimension of each of the plurality of second holes is smaller than a diametrical dimension of each of the plurality of first holes.

8. The textile fabric of claim 1, wherein the main body further includes a plurality of yarns, the plurality of yarns are interlaced with one another to form at least one knitted structure, and the at least one knitted structure includes a plurality of loops sleeved to one another.

9. The textile fabric of claim 8, wherein the plurality of yarns are at least partially elastic yarns.

10. The textile fabric of claim 6, wherein the film layer is made of a material including polyurethane and is a waterproof breathable film layer; the film layer includes a film material layer and a connecting layer, and the connecting layer is disposed on a side of the film material layer and connected with one of the two surfaces; the covering layer is attached to one of the two surfaces by the connecting layer; a material of the film layer is different from a material of the covering layer; a thickness of the film layer is between 20 μm and 450 μm; the covering layer is a fabric and includes a plurality of second holes, and a diametrical dimension of each of the plurality of second holes is smaller than a diametrical dimension of each of the plurality of first holes; the diametrical dimension of each of the plurality of first holes is larger than or equal to 2 mm; a fabric density of the covering layer is larger than a fabric density of the main body; the main body further includes a plurality of yarns, the plurality of yarns are interlaced with one another to form at least one knitted structure, and the at least one knitted structure includes a plurality of loops sleeved to one another; the plurality of yarns are at least partially elastic yarns; as viewed in an axial direction of one of the plurality of yarns, the film layer covers at least ⅓ of an outer circumferential surface of said yarn; and an area of the covering layer covering the main body is smaller than or equal to an area of the film layer covering the main body.
